(19) United States
(12) Patent Application Publication
(10) Pub. No.: US 2024/0001374 A1
(43) Pub. Date: Jan. 4, 2024

(54) SHREDDING DEVICE WITH VENTILATION MECHANISM

(71) Applicant: Manuel Lindner, Spittal/Drau (AT)

(72) Inventors: Manuel Lindner, Spittal/Drau (AT); Richard Thurner, Villach (AT); Peter Schiffer, Spittal/Drau (AT)

(73) Assignee: Manuel Lindner, Spittal/Drau (AT)

(21) Appl. No.: 18/038,388

(22) PCT Filed: Oct. 7, 2021
(86) PCT No.: PCT/EP2021/077708

§ 371 Date: May 23, 2023

(30) Foreign Application Priority Data
Nov. 25, 2020 (EP) 20209673.1

(51) Int. Cl. B02C 18/00; B02C 18/16

(52) U.S. Cl. CPC B02C 18/0084; B02C 18/16

(57) ABSTRACT

The present invention relates to a shredding device comprising: a machine housing in which a drive compartment and a material-receiving chamber are formed, a movable device for shredding material, which is arranged at least in part in the material-receiving chamber of the machine housing, a drive device which is configured to drive the movable device for shredding material and is arranged at least in part in the drive compartment of the machine housing, and a motor-operated ventilation mechanism which is configured to ventilate the drive compartment and comprises a cleaning device for purifying air provided for ventilating the drive compartment.

### FIELD OF THE INVENTION

The present invention relates to a shredding device for shredding material, in particular in the form of waste products.

### PRIOR ART

Commercial waste, industrial waste, domestic waste, etc., for example, (hard) plastic materials, textiles, composites, rubber or waste wood (such as pallets and chipboard), require shredding prior to their final disposal or prior to returning them into the recovered substance cycle of the shredding. Prior art knows single-shaft or multiple-shaft shredders for shredding which are loaded, for example, by wheeled loaders, forklifts or conveyor belts via a hopper for material feed. After shredding, the material is discharged and transported onward by use of a conveyor belt, a conveyor screw, a chain conveyor, or an extraction system, etc.

Machine housings of conventional shredders are used to accommodate the attachments and built-in parts such as the blade rotor and the drive components. One or more rotor shafts are enclosed by a material-receiving chamber/impact chamber in which the shredding process takes place. The one or more rotor shafts are part of the cutting system and are driven by a drive device with, for example, an electric motor, a gearbox, and belts.

During the shredding process, a high level of dust can develop in the surroundings of the shredding device, depending on the material to be shredded. Due to the air circulation in the drive device, the dust load represents a problem for the drive components which are enclosed at least in part for safety reasons due to their rotating parts. Since the cooling of the drive components is restricted by the housing (heat embodiment), relatively large ventilation slots are typically provided in the drive compartment to ensure the air supply and removal for cooling. However, this can inevitably result in dust-laden air entering the drive compartment and causing fouling. Dust can also possibly enter the drive compartment from the material-receiving chamber through openings in the housing. Fouling with dust can lead to overheating and, in extreme cases, to failure of individual components of the drive system. Regular cleaning maintenance is therefore required in prior art.

In view of the above issues, it is therefore an object of the present invention to provide an improved shredding device in which the drive device is sufficiently cooled without becoming so fouled that frequent cleaning maintenance of the drive compartment is required.

### DESCRIPTION

The above object is satisfied by a shredding device according to claim 1. This shredding device (for example, a single-shaft or multi-shaft shredder) comprises a machine housing in which a drive compartment and a material-receiving chamber are formed. The shredding device can weight several tons, for example, more than 1 ton, in particular more than 3 tons, and have dimensions of more than one meter or several meters in length, width, and height. The device can be operated continuously or in batch operation.

The material-receiving chamber is used to receive material to be shredded. The material to be shredded can be, for example, commercial waste, industrial waste, domestic waste, etc., for example, (hard) plastic, textiles, composite materials, rubber or waste wood (such as pallets and chipboard), or organic waste. The shredding takes place in the material-receiving chamber.

Furthermore, the shredding device comprises a movable device for shredding material which is arranged at least in part in the material-receiving chamber of the machine housing. This movable device for shredding material can comprise one or more rotor shafts. A support with shredding tools, in particular blades or baffle plates and possibly breaking hammer tools disposed thereabove for coarse pre-shredding, can be attached to the rotor shaft. Furthermore, the movable device for shredding material can comprise a pusher, with the aid of which the material to be shredded can be pressed towards the one or more rotor shafts.

Furthermore, the shredding device comprises a drive device which is configured to drive the movable device for shredding material and is arranged at least in part in the drive compartment of the machine housing. This drive device can comprise a motor, in particular an electric motor, a belt drive, a gear, and a belt.

Furthermore, the shredding device comprises a motor-operated ventilation mechanism (for example a self-cleaning motor-operated ventilation mechanism) which is configured to ventilate the drive compartment and comprises a cleaning device for purifying air provided for ventilating the drive compartment. The motor-operated ventilation mechanism delivers purified air from the surroundings of the machine housing into the drive compartment in which at least parts of the drive device are disposed. It is thus possible to prevent a significant ingress of dust from the surroundings into the drive compartment. In particular, the fresh air supplied by the engine-operated ventilation mechanism into the drive compartment is also used to cool the components of the drive device. It can therefore be provided that ventilation slits are dispensed with that are intentionally incorporated into the outer walls of the drive compartment, which in prior art put the drive compartment in communication with the surroundings of the machine housing for allowing ambient air to enter into the drive compartment. The motor-operated ventilation mechanism is desirably connected to the drive compartment in as airtight a manner as possible (for example by appropriate feeds and seals).

Since, according to the invention, substantially dust-free air is supplied to the drive compartment and thereby to the components of the drive device disposed therein, regular cleaning maintenance of the drive compartment is no longer necessary or corresponding maintenance intervals can at least be significantly increased. Downtimes of the shredding device can then be significantly reduced over prior art with the corresponding economic benefit.

It is also to be noted that air, previously being supplied from the operating compartment by the ventilation mechanism into the operating compartment and escaping again, can dissipate heat generated by the operation of the drive device in the operating compartment. The air can escape, for example, through openings that are unavoidable by design in the machine housing or the drive housing respectively. The ventilation mechanism is then not only used to keep the operating compartment clean, but also to dissipate operating heat to the surroundings. A respective (possibly open-loop controlled or closed-loop controlled) outlet can be provided in the operating compartment for the controlled discharge of air heated in the operating compartment. With the aid of such an outlet, a well-defined ventilation flow through the drive compartment for efficient ventilation of the same can be formed.

The motor-operated ventilation mechanism can comprise a (radial) blower. Air can be conveyed efficiently into the drive compartment with the aid of such a blower and with relatively little susceptibility to faults from the outside space of the machine housing.

According to a further embodiment, the cleaning device of the motor-operated ventilation mechanism comprises an air pre-separator, with the aid of which dust can be efficiently separated from the ambient air of the machine housing prior to the drive compartment being ventilated. Furthermore, the cleaning device of the motor-operated ventilation mechanism can comprise a perforated plate (in particular arranged upstream of the air pre-separator) for the coarse separation of impurities prior to the drive compartment being ventilated, with the aid of which the operation of the ventilation mechanism can be protected against disruptions caused by larger fouling particles (e.g. plastic particles). The cleaning device can also have an exchangeable fine filter (for example in the form of a filter mat).

According to a further embodiment, the motor-operated ventilation mechanism of the shredding device according to the invention is configured to generate an overpressure in the drive compartment as compared to the surroundings of the machine housing and/or to the material-receiving chamber of the machine housing. The performance of the ventilation mechanism (and, for example, the blower mentioned above) must be configured accordingly. For example, an overpressure (above atmospheric pressure of 1 bar) of more than 0.1 bar or more than 0.5 bar or more than 1.5 bar can be provided. If an overpressure is formed in the drive compartment by the purified air, it can be reliably prevented that a significant proportion of dust penetrates into the drive compartment.

Furthermore, the shredding device can comprise a cooling device for cooling air supplied into the drive compartment by the motor-operated ventilation mechanism. The supply of cooled air into the drive compartment leads to improved heat dissipation (see above) out from the drive compartment.

The above-mentioned object is also satisfied by the provision of a method for ventilating a drive compartment which is formed in a machine housing of a shredding device and in which a drive device for a movable device for shredding material is arranged at least in part. This method comprises the steps of purifying and supplying air from outside the machine housing into the drive compartment of the shredding device by way of a motor-operated ventilation mechanism.

The method can also comprise the step of generating an overpressure in the drive compartment of the shredding device as compared to the surroundings of the machine housing of the shredding device and/or as compared to a material-receiving chamber formed in the machine housing.

The method can furthermore comprise the step of dissipating heat generated by the drive device by forcing air heated in the drive compartment out from the drive compartment with the aid of the motor-operated ventilation mechanism.

Further features and exemplary embodiments of the present invention shall be illustrated in more detail hereafter using the drawings. It is understood that the embodiments do not exhaust the scope of the present invention. It is furthermore understood that some or all features described hereafter can also be combined with each other in different ways.

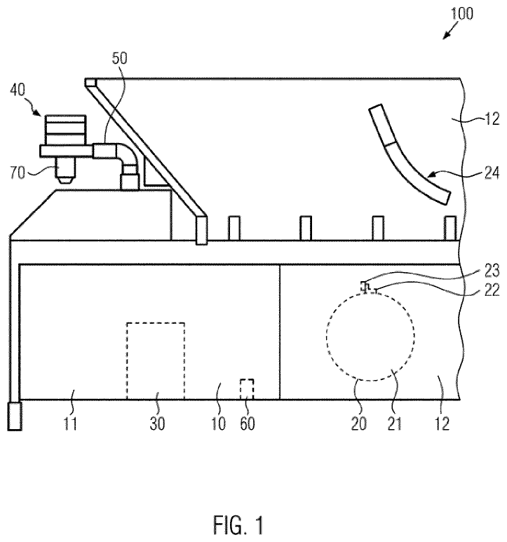

FIG. 1 shows a shredding device according to an embodiment of the present invention.

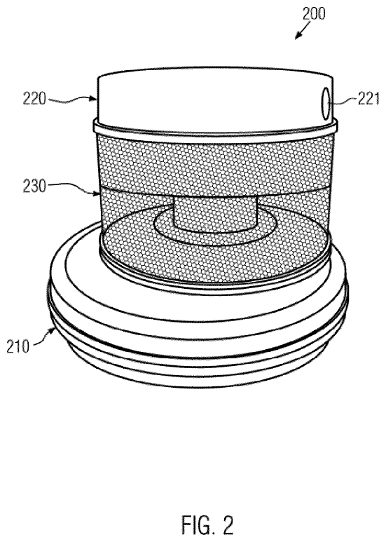

FIG. 2 shows a motor-operated ventilation mechanism for a shredding device according to an embodiment of the present invention.

The present invention provides a shredding device comprising a motor-operated ventilation mechanism that is used to supply fresh air to a drive compartment that is formed in a machine housing of the shredding device for keeping dust out of the drive compartment and for cooling a drive device that is arranged at least in part in the drive compartment.

An exemplary embodiment of such a shredding device 100 is shown in FIG. 1. Shredding device 100 shown in FIG. 1 comprises a machine housing 10 with a drive compartment 11 and a material-receiving chamber 12 which form an inner space of shredding device 100 that is defined at least in part by walls. Drive compartment 11 is separated from material-receiving chamber 12 substantially by a (steel) wall. This inner space can be in particular such a space which can be or is enlarged by superstructures of any type, for example, funnel-shaped structures 12 for material feed. The material to be shredded is introduced into material-receiving chamber 12, and a movable device 20 for shredding material is present within this material-receiving chamber 12 and comprises a rotor 21 on which knives 23 are attached in knife mounts 22.

Furthermore, movable device 20 for shredding material can comprise a pusher 24 for pressing the material to be shredded against rotor 21. Movable device 20 for shredding material is driven, for example, by way of respective drive belts, by a drive device 30 arranged at least in part in drive compartment 11.

According to the invention, shredding device 100 comprises a motor-operated ventilation mechanism 40 which is connected to drive compartment 11 in an airtight manner by way of a connection 50. Purified air is provided from the surroundings of machine housing 10 and supplied with the aid of motor-operated ventilation mechanism 40 into drive compartment 11.

In particular, drive compartment 11 can be pressurized with the aid of motor-operated ventilation mechanism 40. Purified air under overpressure in drive compartment 11 prevents the ingress of dust-contaminated air. Air that again escapes from the drive compartment can dissipate heat from drive compartment 11 which is generated by drive device 30 during the operation of shredding device 100. The air is let out from drive compartment 11, for example, via an outlet 60 that is provided in a wall of drive compartment 11 and can be open-loop controlled or closed-loop controlled. A cooling device 70 can be provided in or at motor-operated ventilation mechanism 40 and can be used to cool the air that is to be supplied to drive compartment 11.

An example of a motor-operated ventilation mechanism for a shredding device, for example, motor-operated ventilation mechanism 40 of shredding device 100 shown in FIG. 1, is illustrated in FIG. 2. Motor-operated ventilation mechanism 200 shown in FIG. 2 has a blower 210 for the aspiration of air, for example, from the surroundings of machine housing 10 shown in FIG. 1. Blower 210 can be configured as a radial blower. Furthermore, motor-operated ventilation mechanism 200 comprises an air pre-separator 220 which is used to separate dust from the air prior to drive compartment 11 being ventilated with the air. The dust leaves air pre-separator 220 via a respective dust outlet 221. Furthermore, a perforated plate 230 (made, for example, from a metal or plastic material) is provided at the air inlet of motor-operated ventilation mechanism 200. Larger particles (in particular larger than dust in the ambient air) can be collected at this perforated plate 230. Perforated plate 230 can be attached to the body of motor-operated ventilation mechanism 200, for example, using edge sealing strips.

According to the invention, a shredding device improved over prior art can thus be provided in which a motor-operated ventilation mechanism is used to ventilate a drive compartment or to generate an overpressure in the drive compartment in order to prevent contamination of the drive compartment and to cool components of a drive device disposed in the drive compartment.

1. A shredding device comprising:
a machine housing in which a drive compartment and a material-receiving chamber are formed;
a movable device for shredding material which is arranged at least in part in said material-receiving chamber of said machine housing;
a drive device which is configured to drive said movable device for shredding material and is arranged at least in part in said drive compartment of said machine housing; and
a motor-operated ventilation mechanism which is configured to ventilate said drive compartment and comprises a cleaning device for purifying air provided for ventilating said drive compartment.

2. The shredding device according to claim 1 in which said motor-operated ventilation mechanism comprises a blower.

3. The shredding device according to claim 1 in which said cleaning device of said motor-operated ventilation mechanism comprises an air pre-separator for separating dust from the air prior to said drive compartment being ventilated with the air.

4. The shredding device according to claim 1 in which said cleaning device of said motor-operated ventilation mechanism comprises a perforated plate for coarse separation of impurities from the air prior to said drive compartment being ventilated with the air.

5. The shredding device according to claim 1 in which said motor-operated ventilation mechanism is structured to generate an overpressure in said drive compartment as compared to at least one selected from the group consisting of (ii) the surroundings of said machine housing and (ii) said material-receiving chamber of said machine housing.

6. The shredding device according to claim 1 in which said movable device for shredding material comprises at least rotor shaft.

7. The shredding device according to claim 1 in which said movable device for shredding material comprises a pusher.

8. The shredding device according to claim 1 which furthermore comprises a cooling device for cooling air supplied into said drive compartment by said motor-operated ventilation mechanism.

9. The shredding device according to claim 1, where said drive compartment is not in communication with the surroundings of said machine housing by way of ventilation slits that are configured to allow ambient air to enter into said drive compartment.

10. The shredding device according to claim 1, where said drive compartment comprises an outlet for letting out air supplied by said ventilation mechanism and wherein said outlet comprises an open-loop controlled or closed-loop controlled outlet.

11. The shredding device according to claim 1, where said shredding device is a single-shaft or a multi-shaft shredder.

12. A method for ventilating a drive compartment which is formed in a machine housing of a shredding device and in which a drive device for a movable device for shredding material is arranged, the method comprising:
purifying air from outside said machine housing; and supplying the purified air into said drive compartment of said shredding device with the aid of a motor-operated ventilation mechanism.

13. The method according to claim 12, further comprising generating an overpressure in said drive compartment of said shredding device as compared to at least one selected from the group consisting of (i) the surroundings of said machine housing of said shredding device (ii) a material-receiving chamber formed in said machine housing.

14. The method of claim 12, further comprising dissipating heat generated by said drive device by forcing air heated in said drive compartment out from said drive compartment with the aid of said motor-operated ventilation mechanism.

15. A shredding device according to claim 3 in which said cleaning device of said motor-operated ventilation mechanism comprises a perforated plate for coarse separation of impurities from the air prior to said drive compartment being ventilated with the air.

16. The shredding device according to claim 3 in which said motor-operated ventilation mechanism is structured to generate an overpressure in said drive compartment as compared to at least one selected from the group consisting of (i) the surroundings of said machine housing and (ii) said material-receiving chamber of said machine housing.

17. The shredding device according to claim 4 in which said motor-operated ventilation mechanism is structured to generate an overpressure in said drive compartment as compared to at least one selected from the group consisting of (i) the surroundings of said machine housing and (ii) said material-receiving chamber of said machine housing.

18. The shredding device according to claim 3 which furthermore comprises a cooling device for cooling air supplied into said drive compartment by said motor-operated ventilation mechanism.

19. The shredding device according to claim 4 which furthermore comprises a cooling device for cooling air supplied into said drive compartment by said motor-operated ventilation mechanism.

20. The shredding device according to claim 5 which furthermore comprises a cooling device for cooling air supplied into said drive compartment by said motor-operated ventilation mechanism.
